(19) United States
(12) Patent Application Publication
(10) Pub. No.: US 2021/0355265 A1
(43) Pub. Date: Nov. 18, 2021

(54) TRANSPARENT TPU BLENDS WITH PYRROLIDONE-CONTAINING POLYAMIDES

(71) Applicant: BASF SE, Ludwigshafen am Rhein (DE)

(72) Inventors: Motonori YAMAMOTO, Ludwigshafen (DE); Roland Helmut KRAEMER, Shanghai (CN)

(73) Assignee: BASF SE, Ludwigshafen am Rhein (DE)

(21) Appl. No.: 16/322,635

(22) PCT Filed: Jul. 11, 2017
(86) PCT No.: PCT/EP2017/067451

§ 371 Date: Feb. 1, 2019

(30) Foreign Application Priority Data
Aug. 2, 2016 (EP) 16182363.8

(51) Int. Cl. C08G 18/76; C08G 18/48; C08G 18/32; C08L 75/08; C08K 5/00; C08K 7/02; C08L 77/02; C08L 79/04

(52) U.S. Cl. CPC C08G 18/7671; C08G 18/4854; C08G 18/3206; C08L 75/08; C08L 2207/04; C08K 7/02; C08L 77/02; C08L 79/04; C08K 5/0066

(57) ABSTRACT

Thermoplastic molding materials comprising

A) 10 to 98 wt % of a thermoplastic polyurethane,

B) 1 to 50 wt % of a thermoplastic polyamide comprising units derived from 2-pyrrolidone,

C) 0 to 40 wt % of a halogen-free flame retardant,

D) 0 to 60 wt % of a fibrous or particulate filler or mixtures thereof,

E) 0 to 30 wt % of further added substances,

wherein the weight percentages A) to E) sum to 100%.

The invention relates to thermoplastic molding materials comprising
A) 10 to 98 wt % of a thermoplastic polyurethane,
B) 1 to 50 wt % of a thermoplastic polyamide comprising units derived from 2-pyrrolidone,
C) 0 to 40 wt % of a halogen-free flame retardant,
D) 0 to 60 wt % of a fibrous or particulate filler or mixtures thereof,
E) 0 to 30 wt % of further additives,
wherein the weight percentages A) to E) sum to 100%.

The present invention further relates to flame retardant molding materials composed of these polymer components and to the use of such molding materials for producing fibers, films and moldings, and to the resultant moldings, fibers and films of any type.

Pyrrolidone-containing polymers are described in the teachings of U.S. Pat. No. 3,678,015 and DE-A 4333238A1.

Academic studies (Ali et. al., Macromolecules 2013, 46, 3719-3725) describe such polyamides as biodegradable polymers.

Thermoplastic polyurethanes (TPU) find use as materials in numerous applications, for instance as cable sheathings, floor coverings, nonslip handles, on account of their high mechanical durability and very good surface quality. Due to the very fine microstructure of the semicrystalline domains transparent materials may be produced.

A substantial disadvantage of TPU is the relatively high heat release rate and the virtually residueless combustion as demonstrable by thermogravimetric measurements and cone calorimeter measurements. In many applications requiring flame retardancy untreated TPUs therefore cannot be employed. Flame retardants are therefore employed to retard possible flame spread. It is sought through the use of the flame retardants to reduce the heat release rate and increase the amount of residue on combustion. However, the flame retardants generally have the result that the TPU molding materials are no longer transparent and the mechanical properties are markedly impaired.

The advantages of TPU as a material include the extremely high impact strength and extensability of the material. However, the hardness of the material is adjustable only over a limited range and in particular the maximum achievable yield stress is limited. It would be desirable to broaden the field of application of TPU, in particular through higher hardnesses and yield stresses, while retaining high transparency and impact strength.

Blends of thermoplastic polyether-polyurethane with PA12 are commercially available. These materials exhibit excellent hydrolysis resistance, low-temperature flexibility and resistance to microorganisms. However, PA 12 likewise features a high heat release rate and a virtually residueless combustion (Z. Wan, X. Du, R. Song, X. Meng, Z. Jiang and T. Tang, Polymer, 2007, 48, 7301). Mixtures of TPU with PA 12 are additionally opaque and readily miscible molding materials are achievable only in limited mixing ratios and for specific types (S. S. Pesetskii, V. Fedorov, B. Jurkowski and N. D. Polosmak, Journal of Applied Polymer Science, 1999, 74, 1054).

The present invention accordingly has for its object to provide thermoplastic TPU molding materials which through mixing of polyamides with pyrrolidone-containing polyamides exhibit a lower heat release capacity and a lower specific heat of combustion which should result in an intrinsically better flame retardancy of the materials.

The molding materials defined in the introduction have accordingly been found. Preferred embodiments may be found in the dependent claims.

It has surprisingly been found that in blends of TPU with pyrrolidone-containing polyamides it is possible both to increase thermal stability and reduce the heat release rate while also markedly improving the maximum yield stress of the material. It is also surprising that in such blends a very high breaking elongation and even the transparency of the material can be retained. Compared to PA 12, mixtures of the pyrrolidone-containing polyamides with TPA are markedly easier to produce in customary extrusion processes.

As component A) the molding materials according to the invention comprise 10 to 98 wt %, preferably 20 to 90 wt % and in particular 30 to 80 wt % of at least one thermoplastic polyurethane.

Thermoplastic polyurethanes are well known. Production is carried out by reaction of (a) organic and/or modified isocyanates with (b) isocyanate-reactive compounds, in particular difunctional polyols, having a number-average molecular weight of 0.5×10³ g/mol to 10×10³ g/mol and optionally (c) chain extenders having a molecular weight of 0.05×10³ g/mol to 0.499×10³ g/mol optionally in the presence of (d) catalysts and/or (e) customary auxiliaries and/or additives and/or flame retardants (f).

The components (a) isocyanate, (b) isocyanate-reactive compounds/polyol (c) chain extenders are also referred to individually or collectively as synthesis components. The synthesis components including the catalyst and/or the customary auxiliaries and/or additives are also referred to as input materials.

In order to adjust the hardness and melt index of the TPU the employed amounts of synthesis components (b) and (c) may be varied in their molar ratios, wherein hardness and melt viscosity increase with increasing content of chain extender (c) while melt index decreases.

To produce relatively soft thermoplastic polyurethanes, for example those having a Shore A hardness of less than 95, preferably of 95 to 75, in particular at 90 to 80 Shore A (measured according to DIN 53505), the essentially difunctional polyols (b) also referred to as polyhydroxyl compounds (b) and the chain extenders (c) may preferably be used advantageously in molar ratios of 1:1 to 1:5, preferably 1:1.5 to 1:4.5, so that the resulting mixtures of the synthesis components (b) and (c) have a hydroxyl equivalent weight of greater than 200, and especially of 230 to 450, while to produce relatively hard TPUs, for example those having a Shore A hardness of greater than 98, preferably of 55 to 75 Shore D, the molar ratios of (b):(c) are in the range from 1:5.5 to 1:15, preferably from 1:6 to 1:12, so that the obtained mixtures of (b) and (c) have a hydroxyl equivalent weight of 110 to 200, preferably of 120 to 180.

To produce the TPUs according to the invention the synthesis components (a), (b), the chain 5extender (c), are reacted in the presence of a catalyst (d) and optionally auxiliaries and/or additives (e) in amounts such that the equivalence ratio of NCO groups of the isocyanates (a) to the sum of the hydroxyl groups in the components (b) and (c) is 0.95 to 1.10:1, preferably 0.98 to 1.08:1 and in particular approximately 1.0 to 1.05:1.

Preferably produced according to the invention are TPUs where the TPU has a weight-average molecular weight of at least 0.1×10⁶ g/mol, preferably of at least 0.4×10⁶ g/mol and in particular more than 0.6×10⁶ g/mol. The upper limit for the weight-average molecular weight of the TPUs is generally determined by the processability, and also the spectrum of properties desired. The number-average molecular weight of the TPUs is preferably not more than 0.8×10⁶ g/mol. The average molecular weights reported hereinabove for the TPU as well as for the synthesis components (a) and (b) are weight averages determined by gel permeation chromatography.

Preferably employed as organic and/or modified organic isocyanates (a) are aliphatic, cycloaliphatic, araliphatic and/or aromatic isocyanates, more preferably tri-, tetra-, penta-, hexa-, hepta and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane and/or 1,3-bis(isocyanatomethyl)cyclohexane (HXDI), 2,4-paraphenylene diisocyanate (PPDI), 2,4-tetramethylenexylene diisocyanate (TMXDI), 4,4′-,2,4′- and 2,2′-dicyclohexylmethane diisocyanate (H12 MDI), 1,6-hexamethylene diisocyanate (HDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethyldiphenyl diisocyanate, 1,2-diphenylethane diisocyanate and/or phenylene diisocyanate. It is particularly preferable to employ diphenylmethane-diisocyanate isomer mixtures having a 4,4′-MDI proportion of greater than 96 wt % and in particular substantially pure 4,4′-MDI.

Preferred isocyanate-reactive compounds b) are those having a molecular weight between 500 g/mol and 8×10³ g/mol, preferably 0.7×10³ g/mol to 6.0×10³ g/mol, in particular 0.8×10³ g/mol to 4.0×10³ g/mol.

The isocyanate-reactive compound (b) has on average at least 1.8 and at most 3.0 Zerewitinoff-active hydrogen atoms, this number also being referred to as the functionality of the isocyanate-reactive compound (b) and indicating the amount of isocyanate-reactive groups in the molecule theoretically calculated for one molecule from an amount of substance. The functionality is preferably between 1.8 and 2.6, more preferably between 1.9 and 2.2 and in particular 2.

The isocyanate-reactive compound is substantially linear and is one isocyanate-reactive substance or a mixture of different substances, in which case the mixture then meets the recited requirement. However, tri- or higher-functional polyisocyanates are limited in amount such that polyurethanes that are still thermoplastically processable are obtained.

These long-chain compounds are employed in an amount of substance ratio of 1 equivalent mol % to 80 equivalent mol % based on the isocyanate group content of the polyisocyanate.

It is preferable when the isocyanate-reactive compound (b) has a reactive group selected from the hydroxyl group, the amino group, the mercapto group or the carboxylic acid group. It is preferable when the hydroxyl group is concerned. It is particularly preferable when the isocyanate-reactive compound (b) is selected from the group of polyesterols, polyetherols or polycarbonate diols which are also covered by the umbrella term “polyols”.

It is preferable when the isocyanate-reactive compound (b) has a reactive group selected from the hydroxyl group, the amino group, the mercapto group or the carboxylic acid group. It is preferable when the hydroxyl group is concerned. It is particularly preferable when the isocyanate-reactive compound (b) is selected from the group of polyesterols, polyetherols or polycarbonate diols which are also covered by the umbrella term “polyols”.

In preferred embodiments chain extenders (c) are employed; these are preferably aliphatic, araliphatic, aromatic and/or cycloaliphatic compounds having a molecular weight of 0.05×10³ g/mol to 0.499×10³ g/mol and preferably having 2 isocyanate-reactive compounds which are also referred to as functional compound.

The chain extender (c) is preferably present in an amount of 0.1 to 30 parts by weight, preferably in an amount of 1 to 20 wt %, particularly preferably in an amount of 1 to 8 wt %, in each case based on the total mixture of the components (a), (b) and (c).

Suitable monofunctional compounds having a reactive hydrogen atom which may also be used as molecular weight regulators include for example: Monoamines such as for example butyl-, dibutyl-, octyl-, stearyl-, N-methylstearylamine, pyrrolidone, piperidine and cyclohexylamine and monoalcohols such as for example butanol, amyl alcohol, 1-ethylhexanol, octanol, dodecanol, cyclohexanol and ethylene glycol monoethyl ether.

Suitable as higher molecular weight polyhydroxyl compounds having molecular weights of 500 to 8000 g/mol are polyester diols and in particular polyether diols. One example of a compound employed is polybutadienediol, which also gives good results in the production of crosslinkable TPUs. Also contemplated are other hydroxyl-containing polymers having ether or ester groups in the polymer chain, for example polyacetals, such as polyoxymethylenes, and especially formals insoluble in water, for example polybutanediol formal and polyhexanediol formal, and polycarbonates, in particular those composed of diphenyl carbonate and 1,6-hexanediol produced by transesterification. The polyhydroxyl compounds should be at least predominantly linear and for the purposes of the isocyanate reaction must be essentially difunctional. The recited polyhydroxyl compounds may be employed as individual components or in the form of mixtures.

Suitable polyether diols are producible by known processes from one or more alkylene oxides having 2 to 4 carbon atoms in the alkylene radical, for example by anionic polymerization of alkylene oxides with alkali metal hydroxides, such as sodium or potassium hydroxide, or alkali metal alkoxides, such as sodium methoxide, sodium or potassium ethoxide or potassium isopropoxide, as catalysts and with addition of at least one starter molecule comprising 2 to 3, preferably 2, reactive hydrogen atoms in bonded form or by cationic polymerization with Lewis acids, such as inter alia antimony pentachloride, boron fluoride etherate, or fuller's earth as catalysts.

Suitable alkylene oxides are for example tetrahydrofuran, 1,3-propylene oxide, 1,2- and 2,3-butylene oxide and especially preferably ethylene oxide and 1,2-propylene oxide. The alkylene oxides may be used individually, in alternating succession, or in the form of mixtures. Contemplated starter molecules are for example: Water, organic dicarboxylic acids, such as succinic acid, adipic acid and/or glutaric acid, alkanolamines, for example ethanolamine, N-alkylalkanolamines, N-alkyldialkanolamines, for example N-methyl- and N-ethyldiethanolamine and preferably dihydric alcohols optionally comprising ether linkages, for example ethanediol, propane-1,2-diol and propane-1,3-diol, butane-1,4-diol, diethylene glycol, pentane-1,5-diol, hexane-1,6-diol, dipropylene glycol, 2-methylpentane-1,5-diol and 2-ethylbutane-1,4-diol. The starter molecules may be used individually or in the form of mixtures.

Preferably employed are polyetherols composed of 1,2-propylene oxide and ethylene oxide in which more than 50%, preferably 60 to 80%, of the OH groups are primary hydroxyl groups and in which at least a portion of the ethylene oxide is arranged as a terminal block. Such polyetherols are obtainable by, for example, polymerizing onto the starter molecule first the 1,2-propylene oxide and then the ethylene oxide, or first copolymerizing all of the 1,2-propylene oxide in admixture with a portion of the ethylene oxide and then polymerizing thereonto the remainder of the ethylene oxide, or in stepwise fashion polymerizing onto the starter molecule a portion of the ethylene oxide, then all of the 1,2-propylene oxide and then the remainder of the ethylene oxide.

Also particularly suitable are the hydroxyl-containing polymerization products of tetrahydrofuran.

The substantially linear polyetherols typically have molecular weights of 500 to 8000 g/mol, preferably 600 to 6000 g/mol and in particular 800 to 3500 g/mol, wherein the polyoxytetramethylene glycols preferably have molecular weights of 500 to 2800 g/mol. They can be used either individually or else in the form of mixtures with one another.

Suitable polyester diols may preferably be produced from dicarboxylic acids having 2 to 12, preferably 4 to 6, carbon atoms and diols. Contemplated dicarboxylic acids are for example: aliphatic dicarboxylic acids, such as succinic acid, glutaric acid, adipic acid, suberic acid, azelaic acid and sebacic acid, and aromatic dicarboxylic acids, such as phthalic acid, isophthalic acid and terephthalic acid.

The dicarboxylic acids may be used individually or in the form of mixtures, for example in the form of a mixture of succinic, glutaric, and adipic acid. To produce the polyesterols it may optionally be advantageous to employ instead of the dicarboxylic acids the corresponding dicarboxylic acid derivatives, such as dicarboxylic mono- or diesters having 1 to 4 carbon atoms in the alcohol radical, dicarboxylic anhydrides or dicarboxylic dichlorides. Examples of diols include glycols having 2 to 10, preferably 2 to 6 carbon atoms, such as ethylene glycol, diethylene glycol, butane-1,4-diol, pentane-1,5-diol, hexane-1,6-diol, decane-1,10-diol, 2,2-dimethylpropane-1,3-diol, propane-1,3-diol and dipropylene glycol. Depending on the desired properties the diols may be used alone or optionally in mixtures with one another.

Also suitable are esters of carbonic acid with the recited diols, in particular those having 4 to 6 carbon atoms, such as butane-1,4-diol and/or hexane-1,6-diol; condensation products of α-hydroxycarboxylic acids, for example hydroxycaproic acid and preferably polymerization products of lactones, for example optionally substituted a-caprolactone.

Preferably employed as polyester diols are ethanediol polyadipates, 1,4-butanediol polyadipates, ethanediol 1,4-butanediol polyadipates, 1,6-hexanediol neopentyl glycol polyadipates, 1,6-hexanediol 1,4-butanediol polyadipates, and polycaprolactones.

The polyester diols generally have molecular weight of 500 to 6000 g/mol, preferably of 800 to 3500 g/mol.

In preferred embodiments catalysts (d) are employed with the synthesis components. These are in particular catalysts which accelerate the reaction between the NCO groups of the isocyanates (a) and the hydroxyl groups of the isocyanate-reactive compound (b) and, if employed, the chain extender (c).

Preferred catalysts are tertiary amines, in particular triethylamine, dimethylcyclohexylamine, N-methylmorpholine, N,N′-dimethylpiperazine, 2-(dimethylaminoethoxy)ethanol, diazabicyclo-(2,2,2)-octane. In another preferred embodiment the catalysts are organic metal compounds such as titanate esters, iron compounds, preferably iron(III) acetylacetonate, tin compounds, preferably those of carboxylic acids, particularly preferably tin diacetate, tin dioctoate, tin dilaurate, or tin dialkyl salts, more preferably dibutyl tin diacetate, dibutyl tin dilaurate, or bismuth salts of carboxylic acids having 6 to 14 carbon atoms, preferably 8 to 12 carbon atoms. Examples of suitable bismuth salts are bismuth neodecanoate, bismuth decanoate, bismuth 2-ethylhexanoate and bismuth octanoate, wherein bismuth decanoate is preferably employed.

The catalyst (d) is preferably employed in amounts of 0.0001 to 0.1 parts by weight per 100 parts by weight of the isocyanate-reactive compound (b). It is preferable to employ tin catalysts, in particular tin dioctoate.

In a particularly preferred embodiment production of the thermoplastic polyurethane is effected using 2,2′-, 2,4′- and/or 4,4′-diphenylmethane diisocyanate (MDI), preferably 4,4′-diphenylmethane diisocyanate (MDI), and polytetrahydrofuran having a number-average molecular weight of 10³ g/mol and butane-1,4-diol as a chain extender and the reaction is catalyzed by tin dioctoate.

Not only catalysts (d) but also customary auxiliaries (e) may be added to the synthesis components (a) to (c) in the production. Examples include surface-active substances, fillers, nucleating agents, oxidation stabilizers, lubricating and demolding auxiliaries, dyes and pigments, optionally stabilizers, preferably against hydrolysis, light, heat or discoloration, flame retardants, inorganic and/or organic fillers, reinforcing agents and/or plasticizers. Preferred auxiliaries (e) are more particularly described under components C) to E).

As component B) the molding materials according to the invention comprise 1 to 50, in particular 1 to 30, preferably 5 to 30 and in particular 5 to 25, wt % of a thermoplastic polyamide comprising units derived from 2-pyrrolidone.

Römpps Online Lexikon (April 2007) lists the following synonyms for 2-pyrrolidone: pyrrolidin-2-one, 4-aminobutyric acid lactam, γ-butyrolactam, 2-oxopyrrolidone.

Such polyamides B) are obtainable by polycondensation of a mixture, based on 100 mol % of B, of
B1) 10 to 50 mol %, preferably 20 to 50 mol %, of itaconic acid, wherein 0 to 37.5 mol %, preferably 0 to 30 mol %, of further dicarboxylic acids (distinct from itaconic acid) may be present,
B2) 10 to 50 mol %, preferably 20 to 50 mol %, of at least one alkanediamine having 2 to 18 carbon atoms or at least one diamine having an aromatic ring or mixtures thereof.

Preferred components B) are obtainable by polycondensation of a mixture, based on 100 mol % of B, of
B1) 12.5 to 50 mol %, preferably 20 to 50 mol % and in particular 30 to 40 mol % of itaconic acid, wherein 0 to 37.5 mol % of further dicarboxylic acids (distinct from itaconic acid) may be present,
B2) 12.5 to 50 mol %, preferably 20 to 50 and in particular 30 to 40 mol % of at least one diamine comprising an aromatic ring, wherein 0 to 37.5 mol % of further diamines may be present.

The polycondensation is carried out as is generally typical by mixing the monomers in generally aqueous, or predominately aqueous, solution and subsequently removing the solvent at reduced pressure and/or elevated temperature. The temperatures and pressures are generally from 150° C. to 320° C., preferably from 180° C. to 280° C., and from 0 to 30 bar. The residence times are generally from 1 h to 30 h, preferably from 1 h to 20 h.

Depending on the monomer ratio this forms block structures or alternating structures in the polymer chain which shall be illustrated with reference to the following preferred examples:

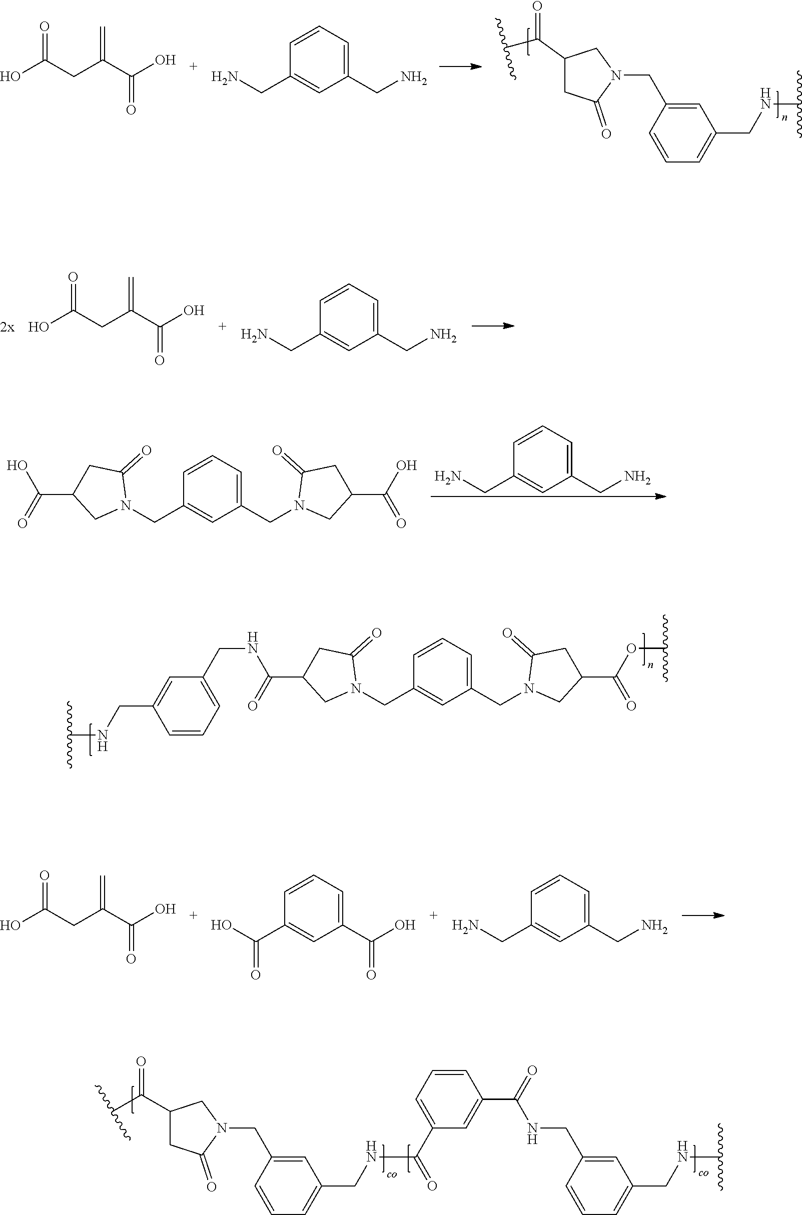

The last equation depicts an example of a preferred copolyamide of itaconic acid/terephthalic acid and m-xylylenediamine.

The molecular weight of components B) is generally Mn (number-average) of component B) according to GPC (PMMA standard and HFIP eluent) from 1000 to 30 000 g/mol, preferably from 1500 to 25 000 g/mol, and the weight average Mw is generally 2000 to 150 000, preferably 2500 to 100 000, g/mol determined by means of GPC as described in detail hereinbelow.

The molecular weight Mn/Mw of the polyamides was determined as follows:

15 mg of the polyamides were dissolved in 10 ml of hexafluoroisopropanol (HFIP). 125 μl respectively of this solution were analyzed by gel permeation chromatography (GPC). The measurements were carried out at room temperature. Elution was effected using HFIP+0.05 wt % of potassium trifluoroacetate salt. The elution rate was 0.5 ml/min. The following column combination was employed (all columns produced by Showa Denko Ltd., Japan): Shodex® HFIP-800P (diameter 8 mm, length 5 cm), Shodex® HFIP-803 (diameter 8 mm, length 30 cm), Shodex® HFIP-803 (diameter 8 mm, length 30 cm). The semiaromatic polyamides were detected by means of an RI detector (differential refractometry). Calibration was effected with narrowly distributed polymethyl methacrylate standards having molecular weights of Mₙ=505 g/mol to Mₙ=2 740 000 g/mol.

As aliphatic dicarboxylic acids B1) and derivatives thereof it is generally those having 2 to 40 carbon atoms, preferably 4 to 18 carbon atoms, that are contemplated. They may be either linear or branched. The cycloaliphatic dicarboxylic acids usable in the context of the present invention are generally those having 7 to 10 carbon atoms and in particular those having 8 carbon atoms. However, it is also possible in principle to employ dicarboxylic acids having a greater number of carbon atoms, for example having up to 30 carbon atoms.

Examples include: malonic acid, succinic acid, glutaric acid, 2-methylglutaric acid, 3-methylglutaric acid, adipic acid, pimelic acid, suberic acid, azelaic acid, sebacic acid, undecanedioic acid, dodecanedioic acid, brassylic acid, tetradecanedioic acid, octadecanedioic acid, fumaric acid, 2,2-dimethylglutaric acid, suberic acid, dimer fatty acid (for example Empol® 1061 from BASF), 1,3-cyclopentanedicarboxylic acid, 1,4-cyclohexanedicarboxylic acid, 1,3-cyclohexanedicarboxylic acid, diglycolic acid, maleic acid, maleic anhydride and 2,5-norbornanedicarboxylic acid.

Likewise employable ester-forming derivatives of the abovementioned aliphatic or cycloaliphatic dicarboxylic acids include in particular di-C₁- to C₆-alkyl esters, such as dimethyl, diethyl, di-n-propyl, diisopropyl, di-n-butyl, diisobutyl, di-t-butyl, di-n-pentyl, diisopentyl or di-n-hexyl esters. Anhydrides of the dicarboxylic acids may likewise be employed.

These dicarboxylic acids or the ester-forming derivatives thereof may be used individually or as a mixture of two or more thereof.

Preference is given to using succinic acid, adipic acid, azelaic acid, sebacic acid, brassylic acid or their respective ester-forming derivatives or mixtures thereof. Particular preference is given to using succinic acid, adipic acid or sebacic acid or their respective ester-forming derivatives or mixtures thereof.

It is especially preferable to use adipic acid or the ester-forming derivatives thereof, such as alkyl esters thereof or mixtures thereof. Preferably employed aliphatic dicarboxylic acids are sebacic acid or mixtures of sebacic acid with adipic acid.

Examples of aromatic dicarboxylic acids generally include those having 6 to 12 carbon atoms and preferably those having 8 carbon atoms. Examples include terephthalic acid, isophthalic acid, phthalic acid, 2,5-furandicarboxylic acid, 5-sulfoisophthalic acid sodium salt, 2,6-naphthalenedicarboxylic acid, 1,4-naphthalenedicarboxylic acid, 1,8-naphthalenedicarboxylic acid, 1,5-naphthalenedicarboxylic acid and anthracenedicarboxylic acid and ester-forming derivatives thereof. Examples include in particular di-C₁- to C₆-alkyl esters, for example dimethyl, diethyl, di-n-propyl, diisopropyl, di-n-butyl, diisobutyl, di-t-butyl, di-n-pentyl, diisopentyl or di-n-hexyl esters. The anhydrides of the dicarboxylic acids a2 are likewise suitable ester-forming derivatives.

However, it is also possible in principle to employ aromatic dicarboxylic acids having a greater number of carbon atoms, for example up to 20 carbon atoms.

The aromatic dicarboxylic acids or the ester-forming derivatives B1) thereof may be used individually or as a mixture of two or more thereof. Particular preference is given to using terephthalic acid or the ester-forming derivatives thereof such as dimethyl terephthalate.

It is also customary to use sulfonate-containing compounds such as an alkali metal or alkaline earth metal salt of a sulfonate-containing dicarboxylic acid or ester-forming derivatives thereof. Preference is given to alkali metal salts of 5-sulphoisophthalic acid or mixtures thereof, the sodium salt being particularly preferable.

The monomers of the polyamides B) comprise as component B2) alkanediamines having 2 to 18 carbon atoms or diamines having an aromatic ring having 6 to 30 carbon atoms or mixtures thereof. “Alkanediamines” is to be understood as meaning not only linear but also branched alkanediamines having 2 to 18 carbon atoms.

Also employable are diamines having an aromatic ring having 6 to 30 carbon atoms selected from the group of m-xylylenediamine, p-xylylenediamine, m- or p-phenylenediamine, 4,4′-oxydianiline, 4,4′-methylenebisbenzylamine, 1,1′-biphenyl-4,4′diamine, 2,5-bis(aminomethyl)furan or mixtures thereof, wherein m- and p-xylylenediamine are preferable.

Examples of suitable alkanediamines include 1,2-ethylenediamine, 1,2-propanediamine, 1,3-propanediamine, 1,2-butanediamine,1,3-butanediamine, 1,4-butanediamine, 1,5-pentanediamine, 2-methyl-1,5-pentanediamine, 1,6-hexanediamine, 2,4-dimethyl-2-ethylhexane-1,3-diamine, 2,2-dimethyl-1,3-propanediamine, 2-ethyl-2-butyl-1,3-propanediamine, 2-ethyl-2-isobutyl-1,3-propanediamine, 2,2,4-trimethyl-1,6-hexanediamine, in particular ethylenediamine, 1,3-propanediamine, 1,4-butanediamine and 2,2-dimethyl-1,3-propanediamine (neopentyldiamine); cyclopentanediamine, 1,4-cyclohexanediamine, 1,2-cyclohexanedimethanol, 1,3-cyclohexanedimethanol, 1,4-cyclohexanedimethanol, 2,5-bis(aminomethyl)tetrahydrofuran, 4,4′-methylenebiscyclohexanamine, 4,4′-methylenebis(2-methylcyclohexanamine), or 2,2,4,4-tetramethyl-1,3-cyclobutanediamine. Mixtures of different alkanediamines may also be employed.

Preferred combinations—in the abovementioned quantitative ratios—of the monomers B1) and B2) are itaconic acid with m- or p-xylylenediamine or mixtures of m- or p-xylylenediamine with 1,6-hexanediamine.

The content of component C) in the molding materials according to the invention is 0 to 40, preferably 1 to 30 and in particular 2 to 25 and in particular 2 to 18 wt % based on the sum of components A) to E).

Further flame retardants suitable for TPU in particular such as metal hydoxides, phosphate esters, etc. may be found in US 2013/0245169 or WO 2009/103765 and explicit reference is therefore made to these documents.

A preferred halogen-free flame retardant C), in particular in combination with glass-fiber-reinforced molding materials, is elemental red phosphorus which may be employed in untreated form.

Particularly suitable, however, are preparations in which the phosphorus is surface-coated with low molecular weight liquid substances such as silicone oil, paraffin oil or esters of phthalic acid (in particular dioctyl phthalate, see EP 176 836) or adipic acid or with polymeric or oligomeric compounds, for example with phenol resins or aminoplasts and also polyurethanes (see EP-A 384 232, DE-A 196 48 503). Such so-called phlegmatizers are generally present in amounts of 0.05 to 5 wt % based on 100 wt % of B).

Also suitable as flame retardants are concentrates of red phosphorus, for example in a polyamide or elastomer E). Polyolefin homopolymers and copolymers in particular are suitable concentrate polymers. However, if no polyamide is used as the thermoplastic the proportion of the concentrate polymer should not exceed 35 wt % based on the weight of components A) to E) in the molding material according to the invention.

Preferred concentrate compositions are
C₁) 30 to 90 wt %, preferably from 45 to 70 wt %, of a polyamide or elastomer E),
C₂) 10 to 70 wt %, preferably from 30 to 55 wt %, of red phosphorus.

The employed polyamide for the batch may be distinct from B) or preferably identical to B) so that incompatibilities or melting point differences do not have a negative effect on the molding material.

The average particle size (d₅₀) of the phosphorus particles distributed in the molding materials is preferably in the range from 0.0001 to 0.5 mm; in particular from 0.001 to 0.2 mm.

As component C) the molding materials according to the invention may comprise 0 to 40, preferably 1 to 30, preferably 1 to 15 and in particular 5 to 10, wt % based on A) to E) of a phosphinic acid salt as the halogen-free flame retardant.

Suitable components C) are phosphinic acid salts of formula (I) or/and diphosphinic acid salts of formula (II) or polymers thereof

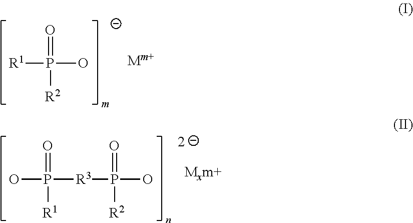

in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or —arylalkylene; p1 M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4, preferably m=3, x=3.

It is preferable when R¹, R² in component B are identical or different and represent hydrogen, methyl, ethyl, n-propyl, isopropyl, n-butyl, tert.-butyl, n-pentyl and/or phenyl.

It is preferable when R³ in component B represents methylene, ethylene, n-propylene, isopropylene, n-butylene, tert-butylene, n-pentylene, n-octylene or n-dodecylene, phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

It is particularly preferable when R¹, R² is hydrogen, methyl, ethyl and M=Al, wherein Al hypophosphite is particularly preferred.

The phosphinates are preferably produced by precipitation of the appropriate metal salts from aqueous solutions. However, the phosphinates may also be precipitated in the presence of a suitable inorganic metal oxide or suitable inorganic metal sulfide as a support material (white pigments, for example TiO₂, SnO₂, ZnO, ZnS, SiO₂). This accordingly affords surface-modified pigments which can be employed as laser-markable flame retardants for thermoplastic polyesters.

As component C) the molding materials according to the invention may comprise 0 to 40, preferably 1 to 30, preferably 1 to 15 and in particular 3 to 12, wt % of a nitrogen-containing flame retardant, preferably of a melamine compound.

The melamine cyanurate preferably suitable according to the invention (component C) is a reaction product of preferably equimolar amounts of melamine (formula I) and cyanuric acid/isocyanuric acid (formulae la and Ib).

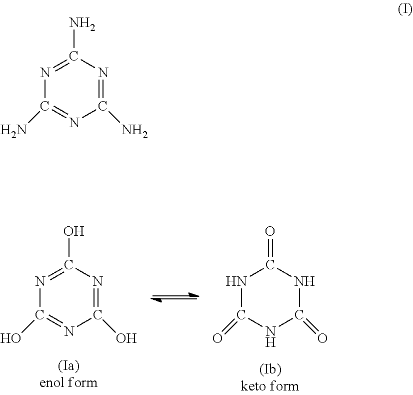 [SMILES: Nc1nc(N)nc(N)n1 ; Oc1nc(O)nc(O)n1 ; O=c1[nH]c(=O)[nH]c(=O)[nH]1]

It is obtained for example by reaction of aqueous solutions of the starting compounds at 90° C. to 100°C. The commercially available product is a white powder having an average particle size d₅₀ of 1.5-7 μm and a d₉₉ value of less than 50 μm.

Further suitable compounds (often also described as salts or adducts) are melamine sulfate, melamine, melamine borate, oxalate, phosphate prim., phosphate sec. and pyrophosphate sec., melamine neopentyl glycol borate, and polymeric melamine phosphate (CAS No. 56386-64-2 and 218768-84-4).

Preference is given to melamine polyphosphate salts of a 1,3,5-triazine compound which have an average degree of condensation number n between 20 and 200 and a 1,3,5-triazine content of 1.1 to 2.0 mol of a 1,3,5-triazine compound, selected from the group consisting of melamine, melam, melem, melon, ammeline, ammelide, 2-ureidomelamine, acetoguanamine, benzoguanamine and diaminophenyltriazine, per mole of phosphorus atom. Preferably, the n-value of such salts is generally between 40 and 150 and the ratio of a 1,3,5-triazine compound per mole of phosphorus atom is preferably between 1.2 and 1.8. The pH of a 10 wt % aqueous slurry of salts produced as per EP-B1095030 is moreover generally more than 4.5 and preferably at least 5.0. The pH is typically determined by adding 25 g of the salt and 225 g of clean water at 25° C. into a 300 ml beaker, stirring the resultant aqueous slurry for 30 minutes and then measuring the pH. The abovementioned n-value, the number-average degree of condensation, may be determined by 31 P solid-state NMR. J. R. van Wazer, C. F. Callis, J. Shoolery and R. Jones, J. Am. Chem. Soc., 78, 5715, 1956 discloses that the number of adjacent phosphate groups gives a unique chemical shift which permits clear distinction between orthophosphates, pyrophosphates, and polyphosphates. EP1095030B1 also describes a process for producing the desired polyphosphate salt of a 1,3,5-triazine compound which has an n-value of from 20 to 200 and where the 1,3,5-triazine content is 1.1 to 2.0 mol of a 1,3,5-triazine compound. This process comprises conversion of a 1,3,5-triazine compound into its orthophosphate salt with orthophosphoric acid followed by dehydration and heat treatment to convert the orthophosphate salt into a polyphosphate of the 1,3,5-triazine compound. This heat treatment is preferably carried out at a temperature of at least 300° C. and preferably at at least 310° C. In addition to orthophosphates of 1,3,5-triazine compounds it is likewise possible to use other 1,3,5-triazine phosphates, including a mixture of orthophosphates and pyrophosphates for example.

Suitable guanidine salts are:

| | CAS No. |
|---|---|
| g carbonate | 593-85-1 |
| g cyanurate prim. | 70285-19-7 |
| g phosphate prim. | 5423-22-3 |
| g phosphate sec. | 5423-23-4 |
| g sulfate prim. | 646-34-4 |
| g sulfate sec. | 594-14-9 |
| guanidine pentaerythritol borate | n.a. |
| guanidine neopentyl glycol borate | n.a. |
| and urea phosphate green | 4861-19-2 |
| urea cyanurate | 57517-11-0 |
| ammeline | 645-92-1 |
| ammelide | 645-93-2 |
| melem | 1502-47-2 |
| melon | 32518-77-7 |

In the context of the present invention “compounds” is to be understood as meaning not only for example benzoguanamine itself and the adducts/salts thereof but also the nitrogen-substituted derivatives and the adducts/salts thereof.

Also suitable are ammonium polyphosphate (NH₄PO₃)ₙ where n is about 200 to 1000, preferably 600 to 800, and tris(hydroxyethyl)isocyanurate (THEIC) of formula IV

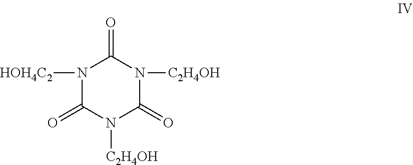

or the reaction products thereof with aromatic carboxylic acids Ar(COOH)ₘ which may optionally be present in a mixture with one another, wherein Ar represents a monocyclic, bicyclic or tricyclic aromatic six-membered ring system and m is 2, 3 or 4.

Suitable carboxylic acids are for example phthalic acid, isophthalic acid, terephthalic acid, 1,3,5-benzenetricarboxylic acid, 1,2,4-benzenetricarboxylic acid, pyromellitic acid, mellophanic acid, prehnitic acid, 1-naphthoic acid, 2-naphthoic acid, naphthalenedicarboxylic acids, and anthracenecarboxylic acids.

Production is effected by reaction of the tris(hydroxyethyl)isocyanurate with the acids, the alkyl esters thereof or the halides thereof according to the processes in EP-A 584 567.

Such reaction products are a mixture of monomeric and oligomeric esters which may also be crosslinked. The degree of oligomerization is typically 2 to about 100, preferably 2 to 20. Preference is given to using mixtures of THEIC and/or reaction products thereof with phosphoruscontaining nitrogen compounds, in particular (NH₄PO₃)ₙ or melamine pyrophosphate or polymeric melamine phosphate. The mixing ratio for example of (NH₄PO₃)ₙ to THEIC is preferably 90 to 50:10 to 50, in particular 80 to 50:50 to 20, wt % based on the mixture of such components B1).

Also suitable are benzoguanamine compounds of formula V

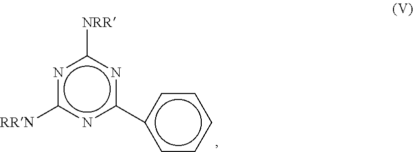

in which R, R′ represents straight-chain or branched alkyl radicals having 1 to 10 carbon atoms, preferably hydrogen, and in particular adducts thereof with phosphoric acid, boric acid and/or pyrophosphoric acid.

Also preferred are allantoin compounds of formula VI,

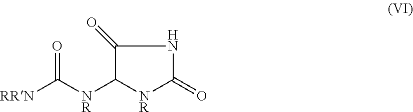

wherein R, R′ are as defined in formula V, and also the salts thereof with phosphoric acid, boric acid and/or pyrophosphoric acid and also glycolurils of formula VII or the salts thereof with the abovementioned acids

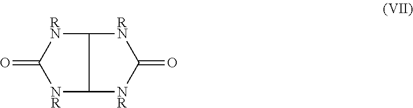

in which R is as defined in formula V.

Suitable products are commercially available or obtainable as per DE-A 196 14 424.

The cyanoguanidine (formula VIII) usable in accordance with the invention is obtainable for example by reacting calcium cyanamide with carbonic acid, the cyanamide produced dimerizing at from pH 9 to pH 10 to afford cyanoguanidine.

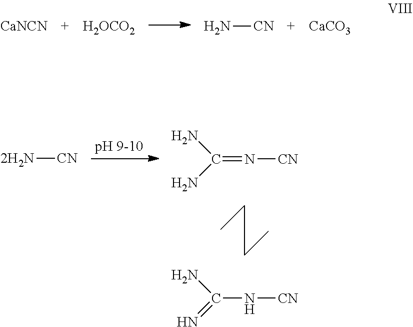

The commercially available product is a white powder having a melting point from 209° C. to 211° C. 1

It is very particularly preferable according to the invention to use melamine cyanurate, the particle size distribution of which is preferably:

d₉₈<25 μm, preferably <20 μm

d₅₀<4.5 μm, preferably <3 μm.

A d₅₀ value is generally understood by those skilled in the art to be the particle size value selected in such a way that the particle size of 50% of the particles is smaller than, and the particle size of 50% of the particles is greater than, said value.

Particle size distribution is typically determined by laser scattering (by a method based on ISO 13320).

Examples of fibrous or particulate fillers D) include carbon fibers, glass fibers, glass beads, amorphous silica, calcium silicate, calcium metasilicate, magnesium carbonate, kaolin, chalk, pulverulent quartz, mica, barium sulfate and feldspar, which may be employed in amounts of from 0 to 50, preferably from 5 to 50, wt %, in particular 10 to 40 wt %.

Preferred fibrous fillers include carbon fibers, aramid fibers and potassium titanate fibers, wherein glass fibers in the form of E glass are particularly preferred. These may be employed as rovings or chopped glass in the commercially customary forms.

The fibrous fillers may have been surface-pretreated with a silane compound in order to improve compatibility with the thermoplastic.

Suitable silane compounds are those of the general formula

(X—(CH₂)ₙ)ₖ—Si—(O—CₘH₂ₘ₊₁)₄₋ₖ

in which the substituents are defined as follows:

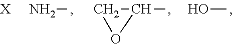

n an integer from 2 to 10, preferably from 3 to 4

m an integer from 1 to 5, preferably from 1 to 2

k an integer from 1 to 3, preferably 1.

Preferred silane compounds are aminopropyltrimethoxysilane, aminobutyltrimethoxysilane, aminopropyltriethoxysilane, aminobutyltriethoxysilane and also the corresponding silanes which comprise a glycidyl group as substituent X.

The silane compounds are generally used for surface coating in amounts of from 0.01 to 2, preferably 0.025 to 1.0 and in particular 0.05 to 0.5 wt % (based on D)).

Acicular mineral fillers are also suitable.

In the context of the present invention “acicular mineral fillers” is to be understood as meaning a mineral filler having a distinctly acicular character. One example is acicular wollastonite. The L/D (length to diameter) ratio of the mineral is preferably 8:1 to 35:1, preferably from 8:1 to 11:1. The mineral filler may optionally have been pretreated with the abovementioned silane compounds but pretreatment is not an essential requirement.

Examples of further fillers include kaolin, calcined kaolin, wollastonite, talc and chalk, precipitated calcite and also lamellar or acicular nanofillers, preferably in quantities of from 0.1 to 10%. Materials preferably used for this purpose are mica, bohmite, bentonite, montmorillonite, vermiculite, zinc oxide in acicular form and hectorite. In order to obtain good compatibility between the lamellar nanofillers and the organic binder the lamellar nanofillers are subjected to organic modification according to the prior art. Addition of the lamellar or acicular nanofillers to the nanocomposites of the invention leads to a further increase in mechanical strength.

As component E) the molding materials may comprise further additives in amounts of 0 to 30, preferably 0 to 20, wt %. Contemplated here in amounts of 1 to 10, preferably 0.5 to 10, in particular 1 to 8, wt % are elastomeric polymers (often also referred to as impact modifiers, elasto-mers or rubbers).

These are very generally copolymers preferably constructed from at least two of the following monomers: ethylene, propylene, butadiene, isobutene, isoprene, chloroprene, vinyl acetate, styrene, acrylonitrile and (meth)acrylate having from 1 to 18 carbon atoms in the alcohol component.

Such polymers are described by way of example in Houben-Weyl, Methoden der organischen Chemie [Methods of organic chemistry], vol. 14/1 (Georg-Thieme-Verlag, Stuttgart, 1961), pages 392 to 406, and in the monograph “Toughened Plastics” (Applied Science Publishers, London, 1977) by C. B. Bucknall.

Some preferred types of these elastomers are set out below:

Preferred components E) are impact modifiers based on ethylene copolymers constructed from:
E₁) 40 to 98 wt %, preferably 50 to 94.5 wt %, of ethylene,
E₂) 2 to 40 wt %, preferably 5 to 40 wt %, of a (meth)acrylate having 1 to 18 carbon atoms, or/and
E₃) 0 to 20 wt %, preferably 0.05 to 10 wt %, of functional monomers selected from the group of ethylenically unsaturated mono- or dicarboxylic acids or of carboxylic anhydrides or epoxy groups or mixtures thereof, wherein the percentages by weight of E₁) to E₃) sum to 100%, or

an ethylene-(meth)acrylic acid copolymer which has been up to 72% zinc-neutralized.

Particular preference is given to ethylene copolymers constructed from:
E₁) 50 to 69.9 wt % of ethylene
E₂) 30 to 40 wt % of a (meth)acrylate having 1 to 18 carbon atoms,
E₃) 0.1 to 10 wt % of functional monomers according to claim 1,

wherein the weight percentages E₁) to E3) sum to 100%.

The proportion of functional groups E₃) is 0.05 to 5, preferably 0.2 to 4, and in particular 0.3 to 3.5, wt % based on 100 wt % of E).

Particularly preferred components E₃) are constructed from of an ethylenically unsaturated mono- or dicarboxylic acid or from a functional derivative of such an acid.

In principle, any of the primary, secondary and tertiary C₁-C₁₈-alkyl esters of acrylic acid or methacrylic acid D₂ is suitable, but preference is given to esters having 1-12 carbon atoms, in particular having 2-10 carbon atoms.

Examples thereof include methyl, ethyl, propyl, n-butyl, isobutyl and tert-butyl, 2-ethylhexyl, octyl and decyl acrylates and the corresponding esters of methacrylic acid. Among these, particular preference is given to n-butyl acrylate and 2-ethylhexyl acrylate.

In addition to the esters the olefin polymers may also comprise acid-functional and/or latently acid-functional monomers of ethylenically unsaturated mono- or dicarboxylic acids or may comprise epoxy-containing monomers.

Further examples of monomers E₃) include acrylic acid, methacrylic acid, tertiary alkyl esters of these acids, in particular butyl acrylate, and dicarboxylic acids such as maleic acid and fumaric acid or anhydrides of these acids and also the monoesters thereof.

“Latently acid-functional monomers” is to be understood as meaning compounds which form free acid groups under the polymerization conditions or during incorporation of the olefin polymers into the molding materials. Examples include anhydrides of dicarboxylic acids having up to 20 carbon atoms, in particular maleic anhydride, and tertiary C₁-C₁₂-alkyl esters of the above-mentioned acids, in particular tert-butyl acrylate and tert-butyl methacrylate.

The production of the above-described ethylene copolymers may be effected by processes known per se, preferably by random copolymerization at high pressure and elevated temperature.

The melt index of the ethylene copolymers is generally in the range from 1 to 80 g/10 min (measured at 190° C. with 2.16 kg load).

The molecular weight of these ethylene copolymers is from 10 000 to 500 000 g/mol, preferably from 15 000 to 400 000 g/mol (Mn determined by GPC in 1,2,4-trichlorobenzene with PS calibration).

Preferably employed commercially available products are Fusabond° A 560, Lucalen® A 2910, Lucalen® A 3110, Nucrel 3990, Nucrel 925, Lotader A x 9800, 3 getabond FS 7 M.

The above-described ethylene copolymers may be produced by processes known per se, preferably by random copolymerization at high pressure and elevated temperature. Corresponding processes are well known.

Other preferred elastomers are emulsion polymers whose production is described for example by Blackley in the monograph “Emulsion Polymerization”. The emulsifiers and catalysts that may be used are known per se.

Copolymers comprising no units E₂) but where the acid component E₃) has been neutralized with Zn are especially preferred. Preference is given here to ethylene-(meth)acrylic acid copolymers which have been up to 72% zinc-neutralized (commercially available as Surlyn® 9520 from DuPont).

It will be appreciated that it is also possible to use mixtures of the rubber types listed above.

Further additives E) may be present in amounts up to 30, preferably up to 20, wt %.

As component E) the molding materials according to the invention may comprise 0.05 to 3, preferably 0.1 to 1.5 and in particular 0.1 to 1 wt % of a lubricant.

Preference is given to aluminum salts, alkali metal salts, alkaline earth metal salts or esters or amides of fatty acids having 10 to 44 carbon atoms, preferably having 12 to 44 carbon atoms. The metal ions are preferably alkaline earth metal and Al, wherein Ca or Mg are particularly preferred.

Preferred metal salts are Ca stearate and Ca montanate, and also aluminum stearate. It is also possible to use mixtures of different salts in any desired mixing ratio.

The carboxylic acids may be mono- or dibasic. Examples include pelargonic acid, palmitic acid, lauric acid, margaric acid, dodecanedioic acid, behenic acid, and particularly preferably stearic acid, capric acid and montanic acid (mixture of fatty acids having from 30 to 40 carbon atoms).

The aliphatic alcohols may be mono- to tetrahydric. Examples of alcohols included n-butanol, n-octanol, stearyl alcohol, ethylene glycol, propylene glycol, neopentyl glycol, and pentaerythritol, preference being given here to glycerol and pentaerythritol.

The aliphatic amines may be mono- to trifunctional. Examples thereof are stearylamine, ethylenediamine, propylenediamine, hexamethylenediamine, and di(6-aminohexyl)amine, wherein ethylenediamine and hexamethylenediamine are particularly preferred. Preferred esters or amides are correspondingly glyceryl distearate, glyceryl tristearate, ethylenediamine distearate, glyceryl monopalmitate, glyceryl trilaurate, glyceryl monobehenate and pentaerythrityl tetrastearate.

It is also possible to use mixtures of different esters or amides or esters in combination with amides in any desired mixing ratio.

As component E) the molding materials according to the invention may comprise 0.05 to 3, preferably 0.1 to 1.5 and in particular 0.1 to 1 wt % of a Cu stabilizer, preferably of a copper(I) halide, in particular in admixture with an alkali metal halide, preferably KI, in particular in a ratio of 1:4.

Suitable salts of monovalent copper preferably include copper(I) complexes with PPh₃, copper(I) acetate, copper(I) chloride, bromide and iodide. These are present in amounts of 5 to 500 ppm of copper, preferably 10 to 250 ppm, based on polyamide.

The advantageous properties are in particular obtained when the copper is in the form of a molecular dispersion in the polyamide. This is achieved when a concentrate comprising polyamide, a salt of monovalent copper and an alkali metal halide in the form of a solid homogeneous solution is added to the molding material. A typical concentrate consists for example of 79 to 95 wt % of polyamide and 21 to 5 wt % of a mixture of copper iodide or bromide and potassium iodide. The concentration of copper in the solid homogeneous solution is preferably between 0.3 and 3, in particular between 0.5 and 2, wt % based on the total weight of the solution and the molar ratio of copper(I) iodide to potassium iodide is between 1 and 11.5, preferably between 1 and 5. Suitable polyamides for the concentrate are homopolyamides and copolyamides, in particular polyamide 6 and polyamide 6.6.

Suitable sterically hindered phenols E) include in principle all compounds having a phenolic structure and having at least one sterically demanding group on the phenolic ring.

Preferably contemplated compounds are for example compounds of formula

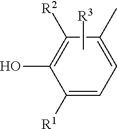

in which:

R¹ and R² represent an alkyl group, a substituted alkyl group or a substituted triazole group, wherein the radicals R¹ and R² may be identical or different and R³ represents an alkyl group, a substituted alkyl group, an alkoxy group or a substituted amino group.

Antioxidants of the recited type are described for example in DE-A 27 02 661 (U.S. Pat. No. 4,360,617).

Another group of preferred sterically hindered phenols derives from substituted benzenecarboxylic acids, in particular from substituted benzenepropionic acids.

Particularly preferred compounds from this class are compounds of the formula

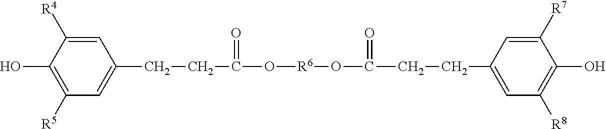

wherein R⁴, R⁵, R⁷ and R⁸ independently of one another represent C₁-C₈ alkyl groups which may themselves be substituted (at least one thereof being a sterically demanding group), and R⁶ represents a divalent aliphatic radical which has from 1 to 10 carbon atoms and which may also have C—O bonds in the main chain.

Preferred compounds of this formula are

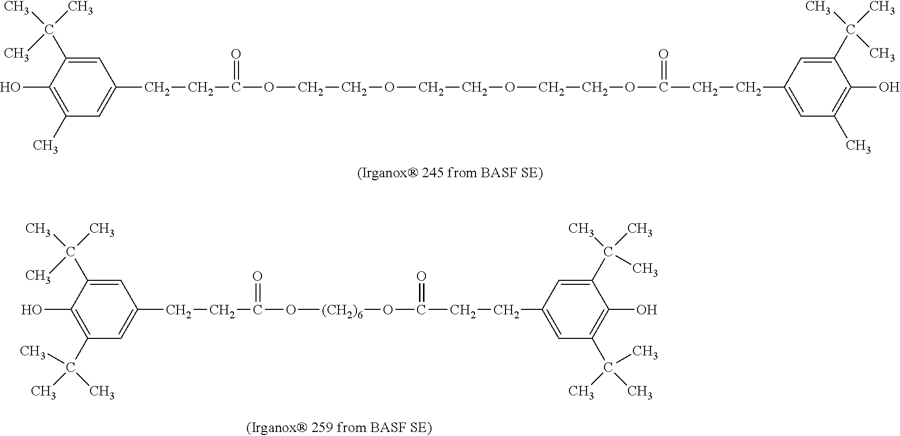

Sterically hindered phenols altogether include for example:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyI)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds that have proven particularly effective and are therefore used with preference are 2,2′-methylenebis(4-methyl-6-tert-butylphenyl), 1,6-hexanediol bis[3-(3,5-di-tert-butyl-4-hydroxyphenyl)propionate](Irganox® 259), pentaerythrityl tetrakis[3-(3,5-di-tert-butyl-4-hydroxyphenyl)propionate] and also N,N′-hexamethylenebis-3,5-di-tert-butyl-4-hydroxyhydrocinnamide (Irganox® 1098) and the above-described Irganox® 245 from BASF SE which is particularly suitable.

The antioxidants E) which may be employed individually or as mixtures are present in an amount of 0.05 up to 3 wt %, preferably from 0.1 to 1.5 wt %, in particular 0.1 to 1 wt %, based on the total weight of the molding materials A) to E).

In some cases, sterically hindered phenols having not more than one sterically hindered group in the ortho-position to the phenolic hydroxy group have proven particularly advantageous, in particular when colorfastness is assessed during storage in diffuse light for prolonged periods. In the context of the present invention stabilizers are additives which protect a plastic or a plastics mixture against damaging environmental influences. Examples include the abovementioned primary and secondary antioxidants, hindered amine light stabilizers, UV absorbers, hydrolysis stabilizers and quenchers. Examples of commercial stabilizers may be found in Plastics Additive Handbook, 5th Edition, H. Zweifel, ed., Hanser Publishers, Munich, 2001 ([1]), pages 98-136.

In a preferred embodiment the UV absorbers have a number-average molecular weight of more than 300 g/mol, in particular more than 390 g/mol. Furthermore, the preferably employed UV absorbers should have a molecular weight of not more than 5000 g/mol, particularly preferably of not more than 2000 g/mol.

Particularly suitable UV absorbers are the group of benzotriazoles. Examples of particularly suitable benzotriazoles are Tinuvin® 213, Tinuvin® 234, Tinuvin® 571 and also Tinuvin® 384 and Eversorb®82. The UV absorbers are typically added in amounts of 0.01 wt % to 5 wt % based on the total mass of TPU, preferably 0.1 wt %-2.0 wt %, in particular 0.2 wt %-0.5 wt %.

An above-described UV stabilization based on an antioxidant and a UV absorber is often not yet sufficient to ensure a good stability of the TPU A) according to the invention against the damaging effect of UV radiation. In this case a hindered amine light stabilizer (HALS) may still be added to the TPU according to the invention in addition to the antioxidant and the UV absorber. The activity of the HALS compounds is based on their ability to form nitroxyl radicals which interferes in the mechanism for oxidation of polymers. HALS are highly efficient UV stabilizers for most polymers.

HALS compounds are common knowledge and commercially available. Examples of commercially available HALS stabilizers may be found in Plastics Additive Handbook, 5th edition, H. Zweifel, Hanser Publishers, Munich, 2001, pages 123-136.

Preferably employed hindered amine light stabilizers are hindered amine light stabilizers having a number-average molecular weight greater than 500 g/mol. Furthermore, the molecular weight of the preferred HALS compounds should be not more than 10000 g/mol, particularly preferably not more than 5000 g/mol.

Particularly preferred hindered amine light stabilizers are bis-(1,2,2,6,6-pentamethylpiperidyl) sebacate (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). Especially preferred is the condensation product of 1-hydroxyethyl-2,2,6,6-tetramethyl-4-hydroxypiperidine and succinic acid (Tinuvin® 622) when the titanium content of the finished product is <150 ppm, preferably <50 ppm, in particular <10 ppm, based on the employed synthesis components.

HALS compounds are preferably employed in a concentration of 0.01 to 5 wt %, particularly preferably of 0.1 to 1 wt %, in particular of 0.15 to 0.3 wt %, based on the total weight of the thermoplastic polyurethane based on the employed synthesis components.

A particularly preferred UV stabilization comprises a mixture of a phenolic stabilizer, a benzotriazole and a HALS compound in the above-described preferred amounts.

As component E) the molding materials according to the invention may comprise 0.05 to 5, preferably 0.1 to 2 and in particular 0.25 to 1.5 wt % of a nigrosin.

Nigrosins are generally a group of black or gray phenazine dyes (azine dyes) in various embodiments (water-soluble, liposoluble, gasoline-soluble), and are related to the indulines, and are used in wool dyeing and printing, for providing black color to silks, and for dyeing leather and for shoe polishes, varnishes, plastics, heat-cured coatings, inks and the like, and also as microscopy dyes.

Nigrosins are obtained industrially by heating nitrobenzene, aniline and aniline hydrochloride with metallic iron and FeCl₃ (name derives from the Latin niger=black).

Component E) may be used as the free base or else as a salt (for example hydrochloride).

Further details relating to nigrosins may be found for example in the electronic encyclopedia Rompp Online, Version 2.8, Thieme-Verlag Stuttgart, 2006, keyword “Nigrosin”.

As component E) the thermoplastic molding materials according to the invention may comprise customary processing aids such as stabilizers, oxidation retarders, agents to counteract thermal degradation and ultraviolet light degradation, lubricants and release agents, colorants such as dyes and pigments, nucleating agents, plasticizers, etc.

Examples of oxidation retarders and heat stabilizers are sterically hindered phenols and/or phosphites and amines (e.g. TAD), hydroquinones, aromatic secondary amines such as diphenylamines, various substituted representatives of these groups and mixtures thereof in concentrations of up to 1 wt % based on the weight of the thermoplastic molding materials.

Examples of further UV stabilizers, which are generally employed in amounts of up to 2 wt % based on the molding material, include various substituted resorcinols, salicylates, benzotriazoles and benzophenones.

Colorants that may be added include inorganic pigments, such as titanium dioxide, ultramarine blue, iron oxide and carbon black, and organic pigments, for example phthalocyanines, quinacridones, perylenes, and also dyes, for example anthraquinones.

Employable nucleating agents include sodium phenylphosphinate, aluminum oxide, silicon dioxide and preferably talc.

The TPUs (component A) may be produced discontinuously or continuously by the known processes, for example using reactive extruders or the belt process by the “one-shot” process or the prepolymer process, preferably by the “one-shot” process. In the “one-shot” process the to-be-reacted components (a), (b), and in preferred embodiments also the components (c), (d) and/or (e), are mixed with one another consecutively or simultaneously, resulting in immediate commencement of the polymerization reaction. In the extruder process the synthesis components (a), (b), and in preferred embodiments also (c), (d) and/or (e), are introduced into the extruder individually or as a mixture and brought to reaction preferably at temperatures of 100° C. to 280° C., preferably 140° C. to 250° C. The obtained polyurethane is extruded, cooled and pelletized.

In a preferred process a thermoplastic polyurethane is produced from the synthesis components isocyanate (a), isocyanate-reactive compound (b), chain extender (c) and, in preferred embodiments, the further input materials (d) and/or (e) in a first step and the components (B to E) are incorporated in a second step.

The above-described preparation is preferably used for production as an injection molding, calendering, powder sintering or extrusion article.

The thermoplastic molding materials according to the invention (components A to E) may be produced by processes known per se by mixing the starting components in customary mixing apparatuses such as screw extruders, Brabender mills or Banbury mills and then extruding the resulting mixture. After extrusion the extrudate may be cooled and comminuted. It is also possible to premix individual components and then add the remaining starting materials individually and/or likewise in the form of a mixture. Mixing temperatures are generally in the range from 180° C. to 240° C.

In a further preferred procedure, components C) to E) may be mixed with a prepolymeric polyamide B), formulated and pelletized. The pelletized material obtained is then condensed to the desired viscosity continuously or batchwise under inert gas in the solid phase at a temperature below the melting point of component B) and subsequently mixed with component A).

The thermoplastic molding materials according to the invention exhibit a better (intrinsic) flame retardancy (heat release capacity), higher thermal stability, better yield stress, higher residue on combustion, high transparency and effective flame retardancy with a lower content of the flame retardant additive in the molding material.

The invention further provides for the use of the polyamides B) for reducing the specific heat of combustion or the heat release capacity or both properties by at least 10%, preferably 20%, compared to a molding material according to claim 1 without component B).

They are therefore suitable for the production of fibers, films and moldings of any type. Examples include: plug connectors, plugs, plug parts, cable harness components, circuit mounts, circuit-mount components, three-dimensionally injection-molded circuit mounts, electrical connection elements and mechatronic components.

The moldings or semifinished products to be produced according to the invention from the thermoplastic molding materials may be used for example in the motor vehicle, electrical, electronics, telecommunications, information technology, entertainment or computer industry, in vehicles and other means of transportation, in ships, spacecraft, in the household, in office equipment, in sport, in medicine, and also generally in articles and parts of buildings, in particular in applications requiring increased flame retardancy.

Possible applications of polyamides with improved flowability for the kitchen and household sectors are production of components for kitchen appliances, for example fryers, smoothing irons, knobs/buttons, and also applications in the garden and leisure sector.

Further applications include: coatings, damping elements, bellows, films, fibers, molded articles, floors for buildings or transport, nonwovens, seals, rollers, shoe soles, hoses, cables, cable plugs, cable sheathings, cushions, laminates, profiles, belts, saddles, foams, by additional foaming of the preparation, union connectors, tow cables, solar modules, trim in automobiles, wiper blades, modifiers for thermoplastic materials, i.e. substances which influence the properties of another material. Each of these uses taken by itself is a preferred embodiment also described as an application. The applications are preferably produced by injection molding, calendering, powder sintering or extrusion.

### EXAMPLES

The following components were used:

Component A1:

Elastollan ® 1185 is a polyurethane constructed from polytetrahydrofuran and butenediol as diol components and MDI as the isocyanate component and has a hardness of 85 Shore A according to DIN 53505.

Component B1A:

Production was carried out based on the procedure in DE A 4333 238. A 1000 ml round-necked flask was charged with 325 g of itaconic acid (ICA), 300 g of deionized water and 347 g of m-xylylenediamine (MXDA). The reaction mixture was held at 108° C. under reflux for 60 min. The temperature was increased stepwise to 200° C. over one hour to distill-off water and the pressure was then reduced stepwise to 3 mbar to carry out the polycondensation under these conditions over a total of 75 minutes.

The polymer (50 mol % ICA, 50 mol % MXDA) had a Tg of 145° C. and a VZ of 23 ml/g measured as a 0.5 wt % solution in 96 wt % sulfuric acid at 25° C. according to ISO 307.

Component B2A:

A 1000 ml four-necked flask was charged with 260 g of itaconic acid, 73 g of adipic acid (AA), 300 g of DI water and 347 g of m-xylylenediamine. The reaction mixture was stirred under reflux for 60 minutes at 108° C. The temperature was then increased to 200° C. over 60 min and water was distilled off. A pressure of 3 mbar was then applied for 15 minutes at the same temperature.

The polymer (40 mol % ICA, 10 mol % AA, 50 mol % MXDA) had a Tg of 126° C., a Mn/Mw of 7830/20100 g/mol and a VN of 33 ml/g.

Component B3A:

A 1000 ml four-necked flask was charged with 195 g of itaconic acid, 146 g of adipic acid (AA), 300 g of DI water and 347 g of m-xylylenediamine. The reaction mixture was stirred under reflux for 60 minutes at 108° C. The temperature was then increased to 200° C. over 60 min and water was distilled off. A vacuum of 3 mbar was then applied for 15 minutes at the same temperature. The polymer (30 mol % ICA, 20 mol % AA, 50 mol % MXDA) had a Tg of 114° C., a Mn/Mw of 9550/25600 g/mol and a VN of 42 ml/g.

Component B4A:

A 1000 ml four-necked flask was charged with 260 g of itaconic acid, 83 g of isophthalic acid (IPA), 300 g of DI water and 347 g of m-xylylenediamine. The reaction mixture was stirred under reflux for 60 minutes at 108° C. The temperature was then increased to 200° C. over 60 min and water was distilled off. At the same temperature, a pressure of 3 mbar was then applied for 15 minutes.

The polymer (40 mol % ICA, 10 mol % IPA, 50 mol % MXDA) had a Tg of 141° C., a Mn/Mw of 3040/7700 g/mol and a VN of 13 ml/g.

Component BSA:

A 1000 ml four-necked flask was charged with 325g of itaconic acid, 200 g of DI water, 174 g of m-xylylenediamine and 208 g of a 70% aqueous solution of 1,6-hexanediamine. The reaction mixture was stirred under reflux for 60 minutes at 108° C. The temperature was then increased to 200° C. over 60 min and water was distilled off. At the same temperature, a pressure of 3 mbar was then applied for 15 minutes.

The polymer (50 mol % ICA, 25 mol % MXDA, 25 mol % HMDA) had a Tg of 109° C., an Mn/Mw of 8950/29900 g/mol and a VN of 52 ml/g.

Component C1:

Melamine cyanurate (Melapur®MC 25 from BASF SE)

Component C2:

Resorcinol bis(diphenyl phosphate) obtainable under the trade name Reofos® RDP from

Chemtura Corporation.

Component C3:

Aluminum diethylphsphinate (Exolit®OP1230 from Clariant GmbH), particle size (d₉₀) =80 μm

Production and processing of the molding materials

The DSM Xplore 15 microcompounder was operated at a temperature of 190° C. The speed of the twin screws was 80 rpm. The residence time of the polymers after feeding of the extruder was about 3 min. The microcompounder indicates during processing the screw force required to achieve the prescribed rotational speed.

To produce moldings from molding materials produced on the DSM Xplore 15 microcompounder the polymer melt was transferred by means of a heated melt vessel into the 10cc Xplore micro-injection molding machine and immediately injected into the mold. A mold temperature of 60° C. was used. Injection molding was effected in three stages; 15 bar for 4 s, 15 bar for 4 s and 16 bar for 4 s.

Further molding materials were processed by means of a Haake PolyLab QC with a Rheomex CTW 100 OS twin-screw extruder (Thermo Fisher Scientific Inc.). Zone 1 and zone 2 of the extruder were maintained at 210° C., zone 3 and the nozzle were maintained at 200° C. The extruder was operated at a speed of 100 rpm, resulting in throughputs of 2.5 kg/h. The torque required to achieve the rotational speed was recorded during the process. The extrudate was pulled through a water bath and pelletized.

Production of moldings from pelletized extrudate was carried out on an Arburg Allrounder 470H injection molding machine with a 30 mm screw diameter (ARBURG GmbH+Co KG) employing a melt temperature of 200° C., a screw speed of 100 rpm, injection pressures of 650 bar to 700 bar, a holding pressure of 600 bar, a back pressure of 50 bar and a mold temperature of 30° C.

The following measurements were carried out:

The heat release capacity, specific heat of combustion and amount of residue after pyrolysis under nitrogen were determined with an FAA Microcombustion calorimeter (from Fire Testing Technology, UK) for samples of 2.5 mg to 3.5 mg in weight, a heating rate of 1° C./s being employed and the pyrolysis oven being heated to 800° C. The afterburner was set to a temperature of 900° C. Measurement was carried out according to the procedure in ASTM D7309-13. The amount of residue was determined immediately after removal of the crucible from the instrument with a high-precision balance.

Measurement of the maximum heat release rate per unit area and the total heat released per unit area was carried out according to ISO 5660-1 but with a different sample geometry and sample holder. Test specimens having dimensions of 60 mm×60 mm×3 mm were placed in a bowl formed from aluminum foil having the same lateral dimensions as the test specimen but an edge height of 1 cm to avoid liquid TPU overflowing the bowl. The test specimens and the aluminum bowl were placed on a calcium silicate sheet having dimensions of 10cm×10 cm×2 cm which was placed in the sample holder described in ISO 5660-1. The upper steel frame of the sample holder (retainer frame) was not attached. All tests were performed with a radiation heat flux of 35 kW/m² at the surface of the test specimen.

Lower values for the heat release capacity and the specific heat of combustion correspond to a higher flame retardancy as demonstrated in the extensive work of Lyon et al (R. Lyon et al., Journal of Thermal Analysis and calorimetry, Vol. 89 (2007) 2, 441-448).

DSC:

The glass transition temperature (Tg) of the polymer was measured using a TA Instruments Q2000 differential scanning calorimeter (DSC). The cooling and heating rate was 20 K/min, the starting weight was about 8.5 mg and the purge gas was helium. Evaluation of the measured curves (second heating curve) was effected as per ISO standard 11357.

TGA:

Thermogravimetric analysis was performed with a TA Instruments Q5000IR instrument. The sample mass was 2 mg to 3 mg. Samples were weighed into aluminum crucibles and the material was heated from 40° C. to 600° C. at a constant heating rate of 20 K min⁻¹ under nitrogen flow.

GPC:

The molecular weight Mn/Mw of the polyamides was determined as follows: 15 mg of the semiaromatic polyamides were dissolved in 10 ml of hexafluoroisopropanol (HFIP). 125 μl respectively of this solution were analyzed by gel permeation chromatography (GPC). The measurements were carried out at room temperature. Elution was effected using HFIP+0.05 wt % of potassium trifluoroacetate salt. The elution rate was 0.5 ml/min. The following column combination was employed (all columns produced by Showa Denko Ltd., Japan): Shodex® HFIP-800P (diameter 8 mm, length 5 cm), Shodex® HFIP-803 (diameter 8 mm, length 30 cm), Shodex® HFIP-803 (diameter 8 mm, length 30 cm). The semiaromatic polyamides were detected by means of an RI detector (differential refractometry). Calibration was effected with narrowly distributed polymethyl methacrylate standards having molecular weights of Mₙ=505 g/mol to Mₙ=2 740 000 g/mol.

Mechanical properties were determined by tensile tests according to ISO 527-2:2012. To determine the modulus of elasticity a rate of 1 mm/min was used and to determine the remaining properties a rate of 50 mm/min was used. The clamping pressure was 3 bar. Shore hardness testing was performed according to DIN 53505. In a departure from the standard the sample thickness was 4 mm.

The transparency of the materials was assessed visually using injection molded sheets having dimensions of 60mm×60 mm×3 mm or alternatively of 130 mm×13 mm×1.6 mm. The microstructure of the TPU mixtures was determined by atomic force microscopy using a Dimension Icon instrument from Bruker Corporation (USA). The tapping operating mode was used and amplitude and phase contrast images were recorded. A silicon tip (TESP from Bruker Corporation) having a cantilever elasticity constant of 42 N/m was used. Uniform sections were prepared at a temperature of −80° C. using a Kryomikrotom EM UC7 FC7 instrument from Leica Microsystems (Wetzlar, Germany). The atomic force micrographs were acquired at room temperature.

The compositions of the molding materials and the results of the measurements are recited in the tables.

Table 1-1 shows that by admixing the pyrrolidone-containing polyamide B1A to TPU a combination of increased modulus of elasticity and markedly increased yield strain may be achieved. The hardness of the material can also be increased. Measurements also show that the heat of combustion of the molding materials produced according to the invention is markedly lower and the pyrolysis residues are markedly increased, thus demonstrating better flame retardancy. Processing was carried out with a Haake Rheomex CTW 100 OS twin-screw extruder

TABLE 1-1
Compositions and material properties

| | V1-1 | 1-1 |
|---|---|---|
| A1 | 100.0 | 80.0 |
| B1A | 0 | 20.0 |
| Modulus of elasticity (MPa) | 23 ± 3 | 45 ± 1 |
| Yield strain [%] | 4.7 ± 0.2 | 6.5 ± 0.1 |
| Elongation at break (%) | >500% | >500% |
| Shore A hardness | 89 | 94 |
| Shore D hardness | 40 | 44 |
| Pyrolysis residue (%) | 2.3 | 12.2 |
| (TGA, N2, 600° C.) | | |
| heat release capacity (J g⁻¹ K⁻¹) | 446 | 340 |
| Specific heat of combustion (kJ g⁻¹) | 28.3 | 23.3 |
| Transparency | very clear | clear |
| Maximum heat release rate cone | 1756 | 901 |
| calorimeter (kW m⁻²) | | |
| Total heat release | 84 | 75 |
| cone calorimeter (MJ m⁻²) | | |

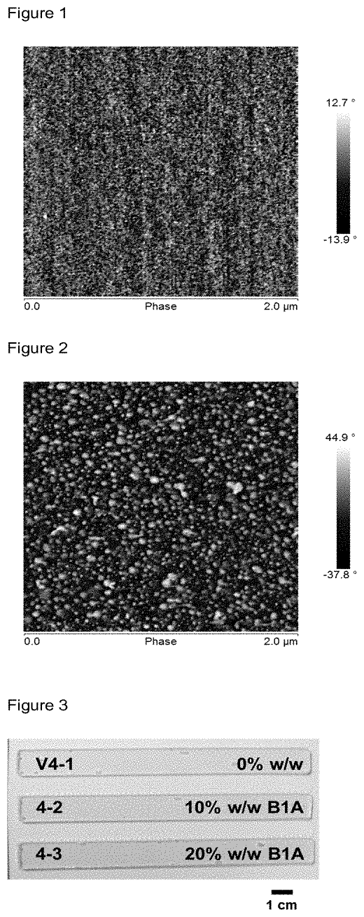

The microstructure of the materials was investigated by atomic force microscopy to obtain further evidence for the retained transparency of the materials. As is apparent from FIG. 1 and FIG. 2 both the pure TPU and the mixture in example 1-1 have morphological structures having dimensions below the wavelength of visible light, thus resulting in transparency of the materials.

FIG. 1: Atomic force microscopy phase contrast micrograph of thermoplastic polyurethane V1-1.

FIG. 2: Atomic force microscopy phase contrast micrograph of inventive molding material 1-1.

Table 2-1 shows that by admixing the pyrrolidone-containing polyamides B2A and B3A to TPU a markedly lower heat of combustion and increased pyrolysis residue amounts compared to V1-1 are achieved, thus demonstrating better flame retardancy.

Processing was carried out with a Haake Rheomex CTW 100 OS twin-screw extruder

TABLE 2-1
Compositions and material properties

| | 2-1 | 2-2 |
|---|---|---|
| A1 | 80.0 | 80.0 |
| B2A | 20.0 | 0 |
| B3A | 0 | 20.0 |
| Pyrolysis residue (%) | 11.8 | 10.5 |
| (TGA, N2, 600° C.) | | |
| Heat release capacity (J g−1 K−1) | 340 | 356 |
| Specific heat of combustion (kJ g−1) | 24.2 | 24.5 |
| Transparency | very clear | very clear |

Table 3-1 shows that by admixing the pyrrolidone-containing polyamides B4A and B5A to TPU a markedly lower heat of combustion and increased pyrolysis residue amounts are achieved, thus demonstrating better flame retardancy.

TABLE 3-1
Compositions and material properties

| | 3-1 | 3-2 | 3-3 |
|---|---|---|---|
| A1 | 80.0 | 80.0 | 60.0 |
| B4A | 20.0 | 0 | 0 |
| B5A | 0 | 20.0 | 40.0 |
| Pyrolysis residue (%) | 12.2 | 6.8 | 11.3 |
| (TGA, N2, 600° C.) | | | |
| heat release capacity (J g⁻¹ K⁻¹) | 314 | 356 | 325 |
| Specific heat of combustion (kJ g⁻¹) | 23.1 | 25.3 | 23.7 |
| Transparency | very clear | very clear | very clear |

To illustrate the transparency Polymer A1 together with the pyrrolidone-containing polymer B1A was processed in the DSM Xplore 15 microcompounder and by injection molding processed into moldings of 1.6 mm in thickness. Table 4-1 describes the formulations and FIG. 1 illustrates that the transparency of the material is retained.

TABLE 4-1
Compositions and material properties

| | V4-1 | 4-2 | 4-3 |
|---|---|---|---|
| A1 | 100.0 | 90.0 | 80.0 |
| B1A | 0 | 10.0 | 20.0 |
| Transparency | very clear | clear | clear |

FIG. 3: Digital photo of the molding materials described in table 4-1

As shown in table 5-1 marked improvements in the combustion values and in residue formation are achieved also for combinations of the pyrrolidone-containing polymers with different types of flame retardants.

The mixing of the molding materials was carried out with the DSM Xplore 15 microcompounder after which moldings of 1.6 mm in thickness were produced by injection molding.

TABLE 5-1
Compositions and material properties

| | V5-1 | 5-2 | 5-3 | V5-4 | 5-5 | 5-6 | V5-7 | 5-8 | 5-9 |
|---|---|---|---|---|---|---|---|---|---|
| A1 | 80.0 | 60.0 | 60.0 | 80.0 | 60.0 | 60.0 | 80.0 | 60.0 | 60.0 |
| B2A | 0 | 20.0 | 0 | 0 | 20.0 | 0 | 0 | 20.0 | 0 |
| B5A | 0 | 0 | 20.0 | 0 | 0 | 20.0 | 0 | 0 | 20.0 |
| C1 | 20.0 | 20.0 | 20.0 | 0 | 0 | 0 | 0 | 0 | 0 |
| C2 | 0 | 0 | 0 | 20.0 | 20.0 | 20.0 | 0 | 0 | 0 |
| C3 | 0 | 0 | 0 | 0 | 0 | 0 | 20.0 | 20.0 | 20.0 |
| Pyrolysis residue (%) | 2.2 | 16.9 | 12.8 | 3.4 | 17.4 | 15.5 | 1.1 | 13.1 | 8.7 |
| (TGA, N2, 600° C.) | | | | | | | | | |
| Heat release capacity | 366 | 212 | 262 | 877 | 542 | 421 | 433 | 358 | 350 |
| (J g−1 K−1) | | | | | | | | | |
| Specific heat of | 22.5 | 18.35 | 20.0 | 25.8 | 20.9 | 22.0 | 26.0 | 24.5 | 23.5 |
| combustion (kJ g−1) | | | | | | | | | |
| Transparency | very | clear | clear | opaque | opaque | opaque | opaque | opaque | opaque |
| | clear | | | | | | | | |

1. A thermoplastic molding material comprising:
A) 10 to 98 wt % of a thermoplastic polyurethane;
B) 1 to 50 wt % of a thermoplastic polyamide comprising units derived from 2-pyrrolidone;
C) 0 to 40 wt % of a halogen-free flame retardant;
D) 0 to 60 wt % of a fibrous or particulate filler or mixtures thereof; and
E) 0 to 30 wt % of further additives, p1 wherein the weight percentages A) to E) sum to 100%.

2. The thermoplastic molding material according to claim 1, comprising:
A) 10 to 98 wt % of the thermoplastic polyurethane;
B) 1 to 30 wt % of the thermoplastic polyamide comprising units derived from 2-pyrrolidone;
C) 1 to 40 wt % of the halogen-free flame retardant
D) 0 to 50 wt % of the fibrous or particular filler or mixtures thereof; and
E) 0 to 30 wt % of the further additives.

3. The thermoplastic molding material according to claim 1, wherein component B) is obtained by polycondensation of a mixture, based on 100 mol % of B, of
B1) 10 to 50 mol % of itaconic acid, wherein 0 to 37.5 mol % of further dicarboxylic acids, distinct from itaconic acid, may be present,
B2) 10 to 50 mol % of at least one alkanediamine having 2 to 18 carbon atoms or at least one diamine having an aromatic ring or mixtures thereof.

4. The thermoplastic molding material according to claim 1, wherein component B) is obtained by polycondensation of a mixture, based on 100 mol % of B, of
B1) 12.5 to 50 mol % of itaconic acid, wherein 0 to 37.5 mol % of further dicarboxylic acids, distinct from itaconic acid, may be present,
B2) 12.5 to 50 mol % of at least one diamine comprising an aromatic ring, wherein 0 to 37.5 mol % of further diamines may be present.

5. The thermoplastic molding material according to claim 3 comprising as component B2) diamines having an aromatic ring selected from the group consisting of m-xylylenediamine, p-xylylenediamine, m- or p-phenylenediamine, 4,4′-oxydianiline, 4,4′-methylenebisbenzylamine, 1,1-biphenyl-4,4′diamine, 2,5-bis(aminomethyl)furan and mixtures thereof.

6. The thermoplastic molding material according to claim 1, wherein component C) comprises red phosphorus, phosphinic acid salts, nitrogen-containing flame retardants or mixtures thereof.

7. The thermoplastic molding material according to claim 1, wherein a molecular weight Mn (number-average) of component B) according to GPC (PMMA standard and HF1P eluent) is from 1000 to 30 000 g/mol.

8. The thermoplastic molding material according to claim 1, wherein component A) has a hardness of 70 to 90 shore A according to DIN 53505.

9. The thermoplastic molding material according to claim 1, wherein component A) comprises polytetrahydrofuran and butanediol as diol components and MDI as the isocyanate component.

10. A method for the production of fibers, films or moldings, comprising employing the thermoplastic molding material according to claim 1.

11. (canceled)

12. A fiber, film or molding obtained from the thermoplastic molding material according to claim 1.
